(19) United States
(12) Patent Application Publication
(10) Pub. No.: US 2008/0056058 A1
(43) Pub. Date: Mar. 6, 2008

(54) TWIN SCREW INTAKE ELEMENTS FOR AN EXTRUDER SYSTEM

(76) Inventor: Babu Padmanabhan, Bangalore (IN)

Correspondence Address: SCHOX PLC, 209 N. MAIN STREET #200, ANN ARBOR, MI, 48104, US

(21) Appl. No.: 11/852,265

(22) Filed: Sep. 7, 2007

Related U.S. Application Data
(63) Continuation-in-part of application No. PCT/IB06/00184, filed on Mar. 8, 2006.
(60) Provisional application No. 60/659,760, filed on Mar. 8, 2005.

(51) Int. Cl. B29B 7/48

(52) U.S. Cl. 366/85

(57) ABSTRACT

An embodiment of the invention is a twin-screw device for an extruder system that includes a first shaft, a second shaft, a first intake element coupled to the first shaft and including a first flight, and a second intake element coupled to the second shaft adjacent the first intake element and including a second flight. The first flight and the second flight are adapted to cooperatively act as a positive displacement pump to convey material when the first intake element and the second intake element are rotated in the same direction. This action, which is a function of the rotational speed of the intake elements, transforms the use of the extruder system from “feed limited” to “torque limited”.

### CROSS-REFERENCE TO RELATED APPLICATIONS

This application is a continuation-in-part of International Application No. PCT/IB2006/001845 filed on 8 Mar. 2006, which claims priority to U.S. Ser. No. 60/659/760 filed on 8 Mar. 2005. Both applications are incorporated in their entirety by this reference.

### TECHNICAL FIELD

This invention relates generally to the extruder system field, and more specifically to twin-screw intake elements within the extruder system field.

### BACKGROUND

A co-rotating twin-screw extruder system is typically used to compound, mix, and otherwise process material, such as plastics, rubber-based materials, food with various additives, fillers, reinforcements, and other modifying agents. When a conventional co-rotating twin-screw extruder system is used for compounding material, the capacity (or the “overall efficiency”) of the system is generally limited by the torque that the system can deliver. This limitation is known as “torque-limited”. In certain low bulk density material applications, however, the capacity of the extruder system is limited, not by the torque, but by the intake capacity at the main hopper. This limitation is known as “feed-limited”. In such a case, sufficient quantity of the low bulk density material is not conveyed through the extruder system because the screw intake elements tend to fluidize the powder, which further decreases the bulk density and compounds the intake capacity problem.

Thus, there is a need in the co-rotating twin-screw extruder system field, and in the broader extruder system field, to create an extruder system that improves the intake capacity for low bulk density materials.

### BRIEF DESCRIPTION OF THE FIGURES

FIG. 1 is a view of the twin-screw device of the preferred embodiment, and

FIG. 2 is cross-sectional radial view of FIG. 1.

FIG. 3 is a detailed view of an element of the twin-screw device, and

FIG. 4 is a cross-section axial view of FIG. 3.

FIG. 5 is a partial view of the twin-screw device and a table of the performance of that twin-screw device incorporated into an extruder system, while

FIG. 6 is a partial view of a conventional twin-screw device and a table of the performance of that conventional twin-screw device incorporated into an extruder system.

### DESCRIPTION OF THE PREFERRED EMBODIMENT

The following description of the preferred embodiment of the invention is not intended to limit the invention to the preferred embodiment, but rather to enable any person skilled in the art to make and use this invention.

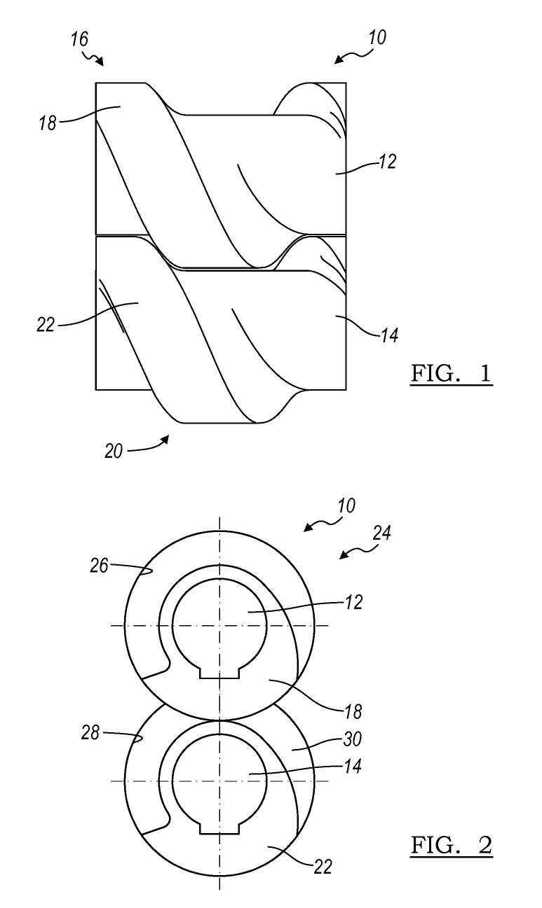

As shown in FIGS. 1 and 2, the preferred embodiment of the invention is a twin-screw device 10 for an extruder system that includes a first shaft 12, a second shaft 14, a first intake element 16 coupled to the first shaft 12 and including a first flight 18, and a second intake element 20 coupled to the second shaft 14 adjacent the first intake element 16 and including a second flight 22. The first flight 18 and the second flight 22 are adapted to cooperatively create a positive displacement pump to convey material when the first intake element 16 and the second intake element 20 are rotated in the same direction Preferably, at each instant of the motion, the first flight 18 and the second flight 22 are adapted to positively propel the material like a snowplow with less slippages or conveying losses when the first intake element 16 and the second intake element 20 are rotated in the same direction. This action, which is a function of the rotational speed of the intake elements, transforms the use of the extruder system from “feed limited” to “torque limited”.

The twin-screw device 10 of the preferred embodiment has been designed to convey material in an extruder system. More specifically, the twin-screw device 10 of the preferred embodiment has been designed to create a propelling effect in extruder systems for low bulk density materials (such as fine powders that trap air like a Talc-Polymer with 50% Talc particles that are sub-micron in size). The extruder system preferably includes a housing 24 that defines a first cylindrical bore 26 and a second cylindrical bore 28 that intersect to form a chamber 30. The first shaft 12 of the twin-screw device 10 preferably rotates within the first cylindrical bore 26, while the second shaft 14 of the twin-screw device 10 preferably rotates within the second cylindrical bore 28. The first shaft 12 and the second shaft 14 are preferably rotated in the same direction, known as co-rotating. The extruder system may alternatively be arranged in any suitable manner. Furthermore, the twin-screw device 10 may alternatively function in any other suitable manner (including compounding or mixing material) in any suitable system and with any suitable material (such as any plastics, rubber-based materials, food with various additives, fillers, reinforcements, and other modifying agents).

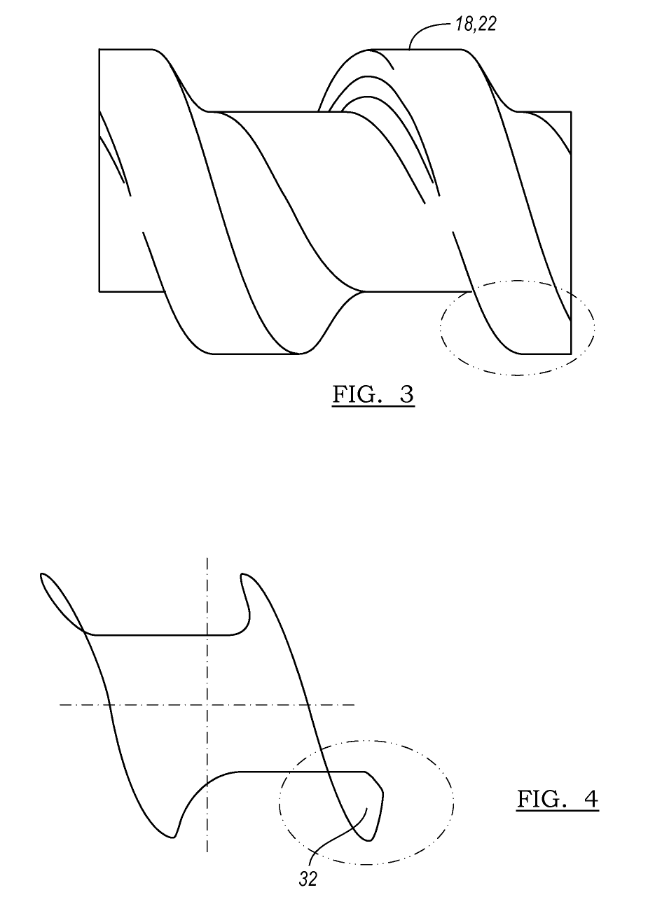

As shown in FIGS. 3 and 4, the first flight 18 and the second flight 22 both define an under-cut 32. The under-cut 32 of the flights 18 and 22 cooperatively function to create a propelling effect when the first intake element 16 and the second intake element 20 are intermeshed. This effect allows the intake elements 16 and 20 to convey material through the extruder system and create a positive displacement even at high speeds of operation. The intake elements 16 and 20 preferably have a single flight, but may alternatively have more than one flight. In an axial cross-section of the flights (best shown in FIG. 4), the size and shape of the under-cut 32 preferably makes an acute angle to the axis of the intake elements 16 and 20. Typically, single flight intake elements of conventional extruder systems have an angle of go degrees or higher under the flight of the intake element. The intake elements 16 and 20 of the preferred embodiment, however, preferably have a less than 85 degree angle and more preferably a 75 degree angle to create the under-cut 32. Alternatively, the intake elements 16 and 20 may have any suitable acute angle to create the under-cut 32. The angle of the under-cut 32 may also be adjusted to include a range of angles such that the propelling effect will still occur within the extruder system when run at a range of speeds. Preferably, the intake elements 16 and 20 are manufactured with the geometry of the preferred embodiment, but may alternatively be manufactured with any suitable geometry to create a seal when the intake elements 16 and 20 are intermeshed.

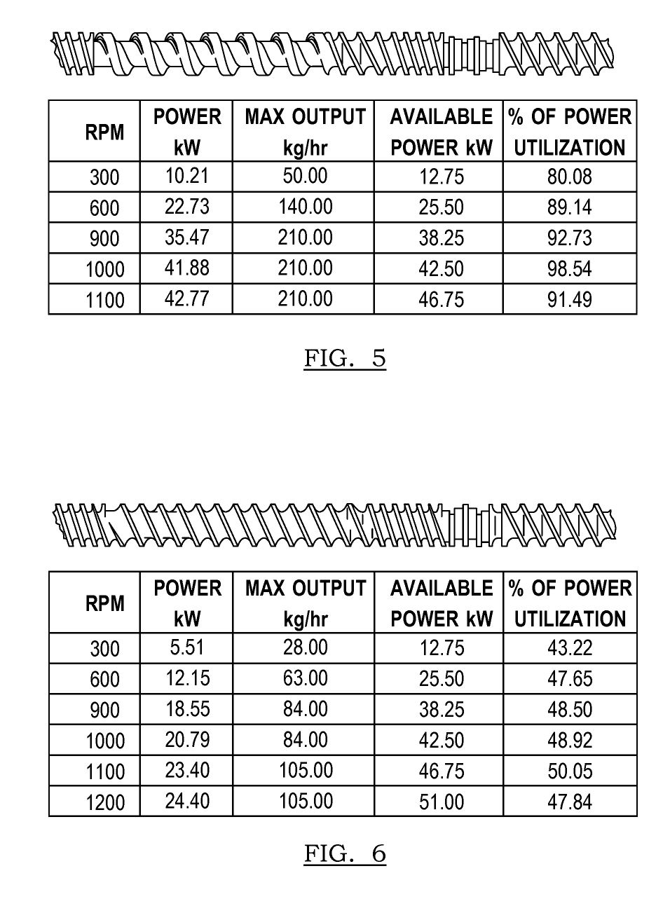

The preferred method of using the extruder system includes running the intake elements 16 and 20 at or above a particular speed. When run at or above a particular speed within an extruder system, the intake elements 16 and 20 create a propelling effect and thus behave as a positive displacement pump to convey material, especially low bulk density materials. The conveyance of the material in such a manner increases the intake capacity at the main hopper, effectively converts the extruder system from “feed-limited” to “torque-limited”, and dramatically increases the overall efficiency of the extruder system by a factor of 2, as shown by a comparison of a conventional twin-screw device in FIG. 6 with the twin-screw device 10 of the preferred embodiment in FIG. 5.

In a first variation, the intake elements 16 and 20 can be used within an extruder system causing the system to convert from feed-limited to torque-limited. In a second variation, the intake elements 16 and 20 can be used within an extruder system causing the system to run as a more efficient devolatilizer. The intake elements 16 and 20 are preferably used within an extruder system such that they behave as one of these variations, but may alternatively be used such that they behave as any suitable application within any suitable environment.

As a person skilled in the art will recognize from the previous detailed description and from the figures and claims, modifications and changes can be made to the preferred embodiments of the invention without departing from the scope of this invention.

I claim:

1. A twin-screw device for an extruder system, comprising:
a first shaft;
a second shaft;
a first intake element coupled to the first shaft and including a first flight; and
a second intake element coupled to the second shaft adjacent the first intake element and including a second flight, wherein the first flight and the second flight define an under-cut, wherein the first flight and the second flight are adapted to cooperatively create a positive displacement pump to convey material when the first intake element and the second intake element are rotated in the same direction.

2. The twin-screw device of claim 1, wherein the under-cut is less than 85°.

3. The twin-screw device of claim 1, wherein the under-cut is approximately 75°.

4. An extruder system for conveying material, comprising:
a housing defining a first cylindrical bore and a second cylindrical bore, wherein the first cylindrical bore and the second cylindrical bore intersect to form a chamber;
the twin-screw device of claim 1, wherein the first shaft rotates within the first bore and the second shaft rotates within the second bore.

5. The extruder system of claim 4, wherein the under-cut is less than 85°.

6. The extruder system of claim 4, wherein the under-cut is approximately 75°.

7. The extruder system of claim 4, wherein the first intake element and the second intake element cooperatively define a propelling effect that creates the positive displacement.

8. The extruder system of claim 5, wherein the propelling effect transforms the use of the extruder system from “feed limited” to “torque limited”.

9. A method for operating a twin-screw device of an extruder system having a first shaft and a second shaft, comprising:
coupling a first intake element to the first shaft and including a first flight;
coupling a second intake element to the second shaft adjacent the first intake element and including a second flight; and
rotating the first intake element and the second intake element in the same direction such that the first flight and the second flight to cooperatively create a propelling effect that acts as a positive displacement pump to convey material.

10. The method of claim 9, wherein the rotating step includes rotating the intake elements such that the intake elements cooperatively create a propelling effect that transforms the use of the extruder system from “feed limited” to “torque limited”.
